(19) United States
(12) Patent Application Publication
(10) Pub. No.: US 2008/0162488 A1
(43) Pub. Date: Jul. 3, 2008

(54) METHOD, SYSTEM AND PROGRAM PRODUCT FOR UPDATING BROWSER PAGE ELEMENTS OVER A DISTRIBUTED NETWORK

(76) Inventors: Christopher J. Karle, Wayland, MA (US); Laurent Hasson, New York, NY (US); Fenil Shah, Peekskill, NY (US)

Correspondence Address: HOFFMAN WARNICK LLC, 75 STATE ST, 14TH FLOOR, ALBANY, NY, 12207, US

(21) Appl. No.: 11/617,835

(22) Filed: Dec. 29, 2006

(51) Int. Cl. G06F 17/30

(52) U.S. Cl. 707/10; 707/E17.009

(57) ABSTRACT

The present invention provides a solution for updating browser page elements over a distributed network. Specifically, the present invention associates a control with a downloaded data element. This association may be provided via the Document Object Model (DOM) of the web page. The control, in turn, is linked with the data element itself, or with a sub-element that depends from the root data element. This dependent data element may have been obtained from the remote location simultaneously with the data element. Upon activation of the control, the dependent data element is displayed without a need for the remote location to be accessed.

### FIELD OF THE INVENTION

The present invention generally relates to data display. Specifically, the present invention provides tools for more efficiently updating browser page elements over a distributed network.

### BACKGROUND OF THE INVENTION

In the world of information technology the manner in which data is displayed is of high importance. Many various methods and structures have been developed for displaying data and/or manipulating browser page elements in manner that is useful and/or aesthetically pleasing. These methods and structures include lists, tables, graphs, pictorial mappings, and the like. The use of these methods and structures in a stand-alone environment allows the data to be more effectively utilized.

However, things become more difficult in a distributed network environment such as the Internet. Very often, Web applications rendered in a browser require more advanced components to visualize complex information. To this extent, the rendering and updating of elements of a browser page, such as a Document Object Model element, using some methods and in certain structures may require sophisticated code. This code may be included with the data on the server or, in the alternative, may comprise a client side application.

One way of providing the advanced components needed to display and manipulate data in a distributed environment involves generating the entire display markup and any accompanying code snippets on the server itself. However, one drawback with the approach it that the client is required to access the server every time a change to the display must be made. That is, each time a user performs an action that significantly changes the display, a request is performed back to the server, which re-renders the page with the updated information and serves the page back to the browser for rendering. This continuous server access can be time consuming. In addition, the refresh speed of the data may be slow due to the need to return both the data and code snippets.

A second strategy for updating browser page elements over a distributed network involves including code components for displaying data on the browser itself. This allows the browser to perform limited updating of the data display without needing to send a request to the server or refresh the current browser page. However, at present, this solution only works with simple controls. However, more complex controls, such as expanding a subtree that depends from a node in a tree or expanding a portion of a list that depends from an element of the list have not been able to be performed by the current display update strategies.

In view of the foregoing, there exists a need for a solution that overcomes the shortcomings of the prior art.

### SUMMARY OF THE INVENTION

In general, the present invention provides a solution for updating browser page elements over a distributed network. Specifically, the present invention associates a control with a downloaded data element. This association may be provided via the Document Object Model (DOM) of the web page. The control, in turn, is linked with the data element itself, or with a sub-element that depends from the root data element. This sub-data element may have been obtained from the remote location simultaneously with the data element. Upon activation of the control, the dependent data element is displayed without a need for the remote location to be accessed.

A first aspect of the present invention provides a method for updating browser page elements delivered over a distributed network, comprising: obtaining, from a remote location, a data structure, the data structure having a set of data elements; obtaining a control associated with a data element of the set of data elements; linking the control with at least one dependent data element of the set of data elements; displaying the data element and the control independent of the at least one dependent data element; and displaying, in response to activation of the control, the at least one dependent data element, the at least one dependent data element being displayed independent of the remote location being accessed.

A second aspect of the present invention provides a system for updating browser page elements delivered over a distributed network, comprising: a data system obtainer for obtaining, from a remote location, a data structure, the data structure having a set of data elements; a control obtainer for obtaining a control associated with a data element of the set of data elements; a linker for linking the control with at least one dependent data element of the set of data elements; and a display for displaying the data element and the control independent of the at least one dependent data element and for displaying, in response to activation of the control, the at least one dependent data element, the at least one dependent data element being displayed independent of the remote location being accessed.

A third aspect of the present invention provides a program product stored on a computer readable medium for updating browser page elements delivered over a distributed network, the computer readable medium comprising: program code for obtaining, from a remote location, a data structure, the data structure having a set of data elements; program code for obtaining a control associated with a data element of the set of data elements; program code for linking the control with at least one dependent data element of the set of data elements; program code for displaying the data element and the control independent of the at least one dependent data element; and program code for displaying, in response to activation of the control, the at least one dependent data element, the at least one dependent data element being displayed independent of the remote location being accessed.

A fourth aspect of the present invention provides a method for deploying an application for updating browser page elements delivered over a distributed network, comprising: providing, to a remote location, a data structure, the data structure having a set of data elements; providing a control associated with a data element of the set of data elements; linking the control with at least one dependent data element of the set of data elements; displaying the data element and the control independent of the at least one dependent data element; and displaying, in response to activation of the control, the at least one dependent data element, the at least one dependent data element being displayed independent of the remote location being accessed.

A fifth aspect of the present invention provides computer software embodied in a propagated signal for updating browser page elements delivered over a distributed network, the computer software comprising instructions for causing a computer system to perform the following: obtain, from a remote location, a data structure, the data structure having a set of data elements; obtain a control associated with a data element of the set of data elements; link the control with at least one dependent data element of the set of data elements; display the data element and the control independent of the at least one dependent data element; and display, in response to activation of the control, the at least one dependent data element, the at least one dependent data element being displayed independent of the remote location being accessed.

A sixth aspect of the present invention provides a method for updating browser page elements delivered over a distributed network, the method comprising managing a computer infrastructure that performs the process described herein; and receiving payment based on the managing.

Therefore, the present invention provides a method, system, and program product for updating browser page elements delivered over a distributed network.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computer system for configuring a data source in a first format for use in an environment requiring a second format according to the present invention.

FIG. 2 shows the obtaining of a control that is associated with a data element according to one embodiment of the present invention.

FIG. 3 shows an initial display of data elements according to one embodiment of an illustrative system of the present invention.

FIG. 4 shows a display of data elements and dependent data elements subsequent to activation of a control according to one embodiment of an illustrative system of the present invention.

FIG. 5 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the present invention provides a solution for updating browser page elements over a distributed network. Specifically, the present invention associates a control with a downloaded data element. This association may be provided via the Document Object Model (DOM) of the web page. The control, in turn, is linked with the data element itself, or with a sub-element that depends from the root data element. This dependent data element may have been obtained from the remote location simultaneously with the data element. Upon activation of the control, the dependent data element is displayed without a need for the remote location to be accessed.

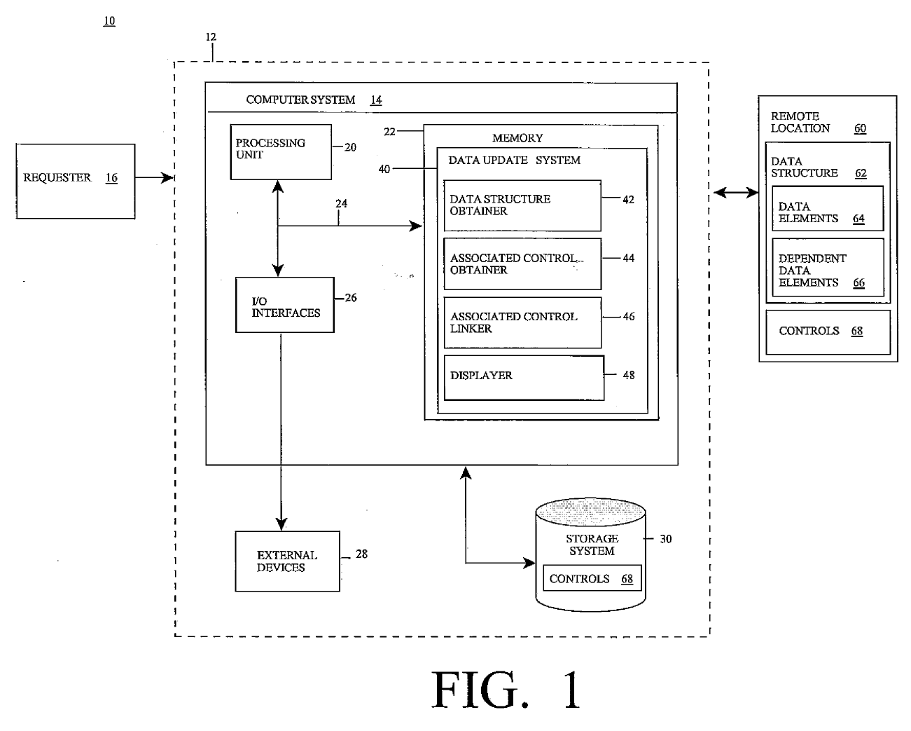

Referring now to FIG. 1, a system 10 for updating browser page elements delivered over a distributed network according to the present invention is shown. Specifically, FIG. 1 depicts a system 10 in which display of a data structure 62 that has been obtained from a remote location 60 can be updated without having to access remote location 60. This updating may serve to add new dependent data elements 66 that depend from data elements 64 that are currently being displayed by activating controls 68 in the browser page elements. These dependent data elements 66 may include complex controls such as sublists, subtables, and/or subtrees and/or may include other dependent controls.

As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by a conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to configure a data source in a first format for use in an environment requiring a second format.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as a data update system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware and/or software. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention. For example, storage system 30 may be used to store one or of data structure 62, data elements 64 and dependent data elements 66 after they are obtained from remote location 60. Furthermore, storage system 30 may also be used to store one or more controls 68 that are associated with data elements 64 and linked to dependent data elements 66 to perform the functions of the present invention. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is data update system 40, which is a software program that provides the functions of the present invention. Data update system 40 provides a system for updating browser page elements delivered over a distributed network. To this extent, data source configuration system 40 includes a data structure obtainer 42, an associated control obtainer 44, an associated control linker 46 and a displayer 48.

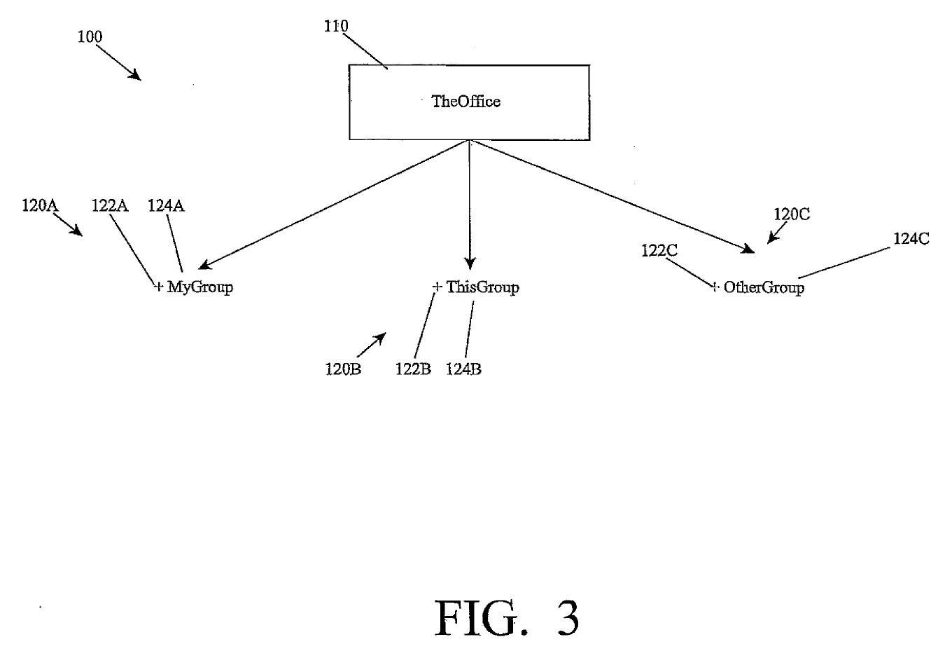

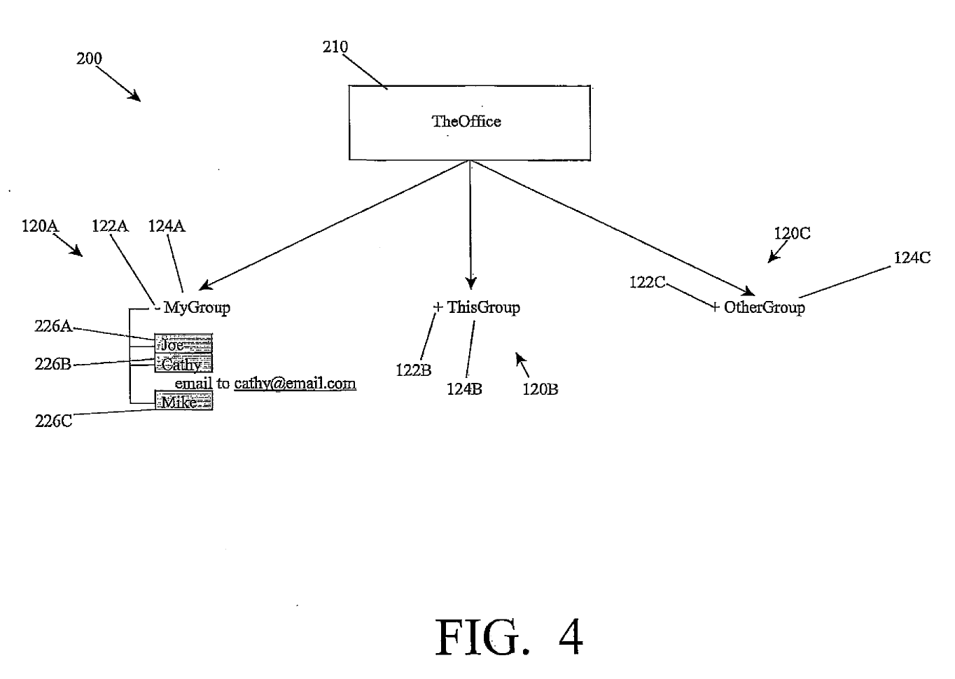

Data structure obtainer 42 obtains data structure 62 from remote location 60. Remote location 60 may be a computer system with attributes that are similar to computer system 14 in computer infrastructure 12. To this extent, remote location 60 may be a stand-alone system, a distributed system or a system having any other configuration now known or later developed. In one embodiment, remote location 60 is a server in a client/server configuration, wherein a requester 16 uses a client to make a request to remote location 60, which then processes the request and returns data structure 62. In any case, data structure 62 comprises data that is sent from remote location 60 for display. As such, data structure 62, may be any type and/or configuration of data now known or later developed. For example, data structure 62 may be structured as a list, table, tree (as in FIG. 3), freeform document, a combination of the above (as in FIG. 4) or any other structure now known or later developed. To this extent, data structure 62 includes a set of data elements 64, 66 having data elements 64 for immediate display and dependent data elements 66 that depend from members of set of data elements but are not immediately displayed.

In a preferred embodiment, data structure obtainer 42 obtains both data elements 64 and dependent data elements 66 of data structure 62 from remote location 60, simultaneously. Upon receipt of data structure 62 from remote location, data structure obtainer 42 may store data elements 64 and/or dependent data elements 66 into one or more variables, such as JavaScript® (Java, JavaScript and the like are registered trademarks of Sun Microsystems, Inc.) variables or innerHTML in elements of the Document Object Model (DOM) of a web page. In one embodiment, only dependent data elements 66 are stored and data elements 64 not, while in an alternative embodiment, both dependent data elements 66 and data elements 64 are both stored. In either case, as will be described in more detail herein, data elements 64 are immediately displayed while dependent data elements 66 are not initially displayed, but rather are stored in the variables for later use, if needed. To this end, the variables may take the form of arrays, tables, trees, or any other data structure that may be used to store data.

Associated control obtainer 44 obtains a control 68 associated with data element 64 the set of data elements 62. Control 68 may be obtained from remote location 60, from a second remote location (not shown), and/or from storage, such as storage system 30. Control 68 may take the form of a control box 226A-C (FIG. 4), a control symbol 120A-C (FIG. 3) or any other form of control that is configured through attributes. Attributes of control 68 could be visible or, in the alternative, can be function based. Accordingly, forms of control 68 include, but are not limited to: a button and/or symbol that includes text from data element 64, a button and/or symbol that is adjacent to or otherwise associated with text from data element 64, a form element (e.g., radio button, drop down box, etc.), a JavaServer Faces (JSF) control, or anything that has attributes that are alive on a client.

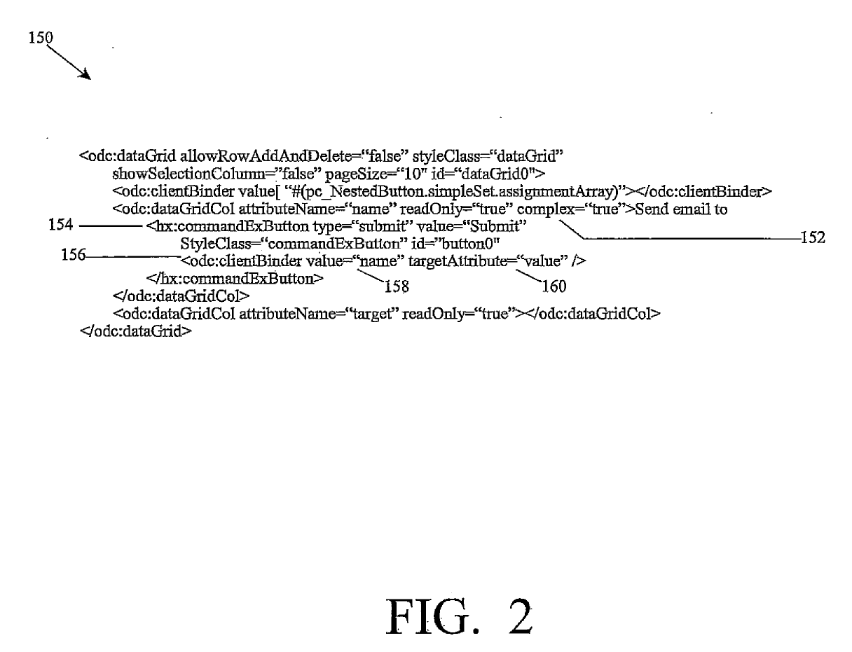

FIG. 2 illustrates one embodiment of the present invention in which control 68 is obtained via at least one JavaScript instruction pertaining to one or more elements of a Document Object Model (DOM) 150 of the web page. This example illustrates code that may be used to associate control 68 with data element 64 in a sample two column table with 1 or more rows. In this example, a statement of complex=“true” 152 indicates that data element 64 is associated with a particular location in the table is to be associated with control 68 and not merely to be inserted in the standard position in the table. Control 68, in this example, is defined by a function for displaying an email address on the button 154 associated with data element 64. The defining function also indicates 156 that the recipient name 158 is to become the value 160 of the text of the displayed command button of control 68.

Associated control linker 46 links control 68 with at least one dependent data element 66 of the set of data elements 62. This linking of control 68 and dependent data element 66 allows dependent data element 66 to be retrieved from storage and displayed upon activation of control 68 without the need for accessing remote location. Dependent data element 66 that is linked with control 68 may be a complex control. To this extent, control 68 may take the form of a sublist, subtable, subtree, a combination thereof, or any other control, visual or not, now known or later developed. In addition, dependent data element 66 may be associated to controls that are themselves associated with other data elements 66.

Referring now to FIGS. 1 and 3 concurrently, displayer 48 initially displays data element 64 and control 68 independent of the at least one dependent data element 66. That is, when data structure 62 and controls 68 are obtained, only data elements 64 and controls 68 are displayed initially. Dependent data elements 66 are not displayed, but rather, may be stored, such as in JavaScript variables in the DOM. In the example display 100 shown in FIG. 3, data element 110 and combination data elements 120A-C are displayed by displayer 48. While data element 110 does not have a control associated with it, combination data elements 120A-C have both data elements 124A-C and associated controls 122A-C in the form of plus symbols.

Referring now to FIGS. 1 and 4 concurrently, a data display 200 is illustrated in which a control, such as control 122A has been activated. In data display 200, displayer 48 displays at least one dependent data element 226A-C in response to activation of control 122A. Those skilled in the art will appreciate that dependent data elements 66 may also be associated with dependent controls as are dependent data elements 226A-C. As such, yet more dependent data elements 66 may be displayed by activation of controls 68 such as the one associated with dependent data element 226B. In any case, the linking of control 122A with dependent data elements 226A-C stored in JavaScript variables in the DOM allows the dependent data elements 226A-C to be displayed by displayer 48 independent of the remote location being accessed.

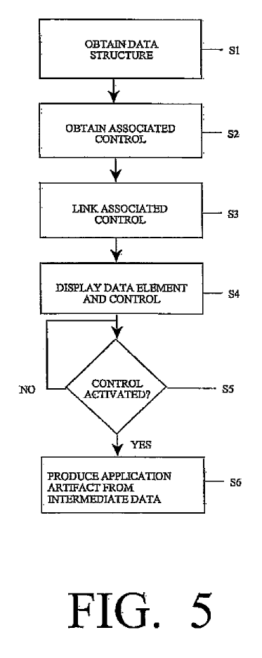

Turning now to FIG. 5, a flow chart of a method according to an embodiment of the present invention is depicted, which is described with reference to FIG. 1. In step S1, data structure obtainer 42 obtains data structure 62 having set of data elements 64, 66 from remote location 60. Data element 64 and dependent data element 66 may be obtained simultaneously from remote location 60. In step S2, associated control obtainer 44 obtains control 68 associated with a data element 64 of the set of data elements 64, 66. As stated herein, control 68 may be obtained via at least one JavaScript instruction in the DOM of the provided data document. In step S3, associated control linker 46 links control 68 with at least one dependent data element 66 of set of data elements 64, 66. As stated above, dependent data element 66 may be a complex control, such as sublist, a subtree and/or a subtable and/or may include one or more controls 68 of its own). In step S4, displayer 48 displays data element 64 and control 68. This display is independent of display of dependent data elements 66. In other words, dependent data elements 66 are not initially displayed in conjunction with data element and control 68, but are instead stored for later use if needed, such as in JavaScript variables in the DOM. In step S5, a determination is made as to whether control 68 has been activated. Finally, in step S6, in response to a determination in step S5 that control 68 has been activated, displayer 48 displays the at least one dependent data element 66 that is linked to control 68. This display of the at least one dependent data element 66 is performed independent of remote location 60 being accessed. As such, the display may be dynamically updated to add and remove data without accessing remote location 60.

While shown and described herein as a method and system for updating browser page elements delivered over a distributed network, it is understood that the invention further provides various alternative embodiments. For example, in one embodiment, the invention provides a computer-readable/useable medium that includes computer program code to enable a computer infrastructure update browser page elements delivered over a distributed network. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a method that performs the process steps of the invention on a subscription, advertising, and/or fee basis. That is, a service provider, such as a Solution Integrator, could offer a service that updates browser page elements delivered over a distributed network. In this case, the service provider can create, maintain, support, etc., a computer infrastructure, such as computer infrastructure 12 (FIG. 1) that performs the process steps of the invention for one or more entities. In return, the service provider can receive payment from the entity(s) under a subscription and/or fee agreement and/or the service provider can receive payment from the sale of advertising content to one or more third parties.

In still another embodiment, the invention provides a computer-implemented method for updating browser page elements delivered over a distributed network. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for updating browser page elements delivered over a distributed network, comprising:
obtaining, from a remote location, a data structure, the data structure having a set of data elements;
obtaining a control associated with a data element of the set of data elements;
linking the control with at least one dependent data element of the set of data elements;
displaying the data element and the control independent of the at least one dependent data element; and
displaying, in response to activation of the control, the at least one dependent data element, the at least one dependent data element being displayed independent of the remote location being accessed.

2. The method of claim 1, the at least one dependent data element being associated with a complex control.

3. The method of claim 2, wherein the complex control includes at least one of a sublist, a subtree and a subtable.

4. The method of claim 1, the control being obtained via at least one JavaScript instruction in a Document Object Model of a provided data document.

5. The method of claim 1, the dependent data element being obtained from the remote location simultaneously with the data element.

6. The method of claim 1, the at least one dependent data element including a dependent control.

7. A system for updating browser page elements delivered over a distributed network, comprising:
a data system obtainer for obtaining, from a remote location, a data structure, the data structure having a set of data elements;
a control obtainer for obtaining a control associated with a data element of the set of data elements;
a linker for linking the control with at least one dependent data element of the set of data elements; and
a display for displaying the data element and the control independent of the at least one dependent data element and for displaying, in response to activation of the control, the at least one dependent data element, the at least one dependent data element being displayed independent of the remote location being accessed.

8. The system of claim 7, the at least one dependent data element being a complex control.

9. The system of claim 8, wherein the complex control includes at least one of a sublist, a subtree and a subtable.

10. The system of claim 8, the control being obtained via at least one JavaScript instruction in a Document Object Model of a provided data document.

11. The system of claim 8, the dependent data element being obtained from the remote location simultaneously with the data element.

12. The system of claim 8, the at least one dependent data element including a dependent control.

13. A program product stored on a computer readable medium for updating browser page elements delivered over a distributed network, the computer readable medium comprising:
program code for obtaining, from a remote location, a data structure, the data structure having a set of data elements;
program code for obtaining a control associated with a data element of the set of data elements;
program code for linking the control with at least one dependent data element of the set of data elements;
program code for displaying the data element and the control independent of the at least one dependent data element; and
program code for displaying, in response to activation of the control, the at least one dependent data element, the at least one dependent data element being displayed independent of the remote location being accessed.

14. The program product of claim 13 the at least one dependent data element being a complex control.

15. The program product of claim 14, wherein the complex control includes at least one of a sublist, a subtree and a subtable.

16. The program product of claim 13, the control being obtained via at least one JavaScript instruction in a Document Object Model of a provided data document.

17. The program product of claim 13, the dependent data element being obtained from the remote location simultaneously with the data element.

18. The program product of claim 13, the at least one dependent data element including a dependent control.

19. A method for deploying an application for updating browser page elements delivered over a distributed network, comprising:
providing, to a remote location, a data structure, the data structure having a set of data elements;
providing a control associated with a data element of the set of data elements;
linking the control with at least one dependent data element of the set of data elements;
displaying the data element and the control independent of the at least one dependent data element; and
displaying, in response to activation of the control, the at least one dependent data element, the at least one dependent data element being displayed independent of the remote location being accessed.

20. The method of claim 19, the control being obtained via a Document Object Model of a provided data document.
